(19) United States
(12) Patent Application Publication
(10) Pub. No.: US 2009/0301085 A1
(43) Pub. Date: Dec. 10, 2009

(54) Turbocharger for an internal combustion engine

(76) Inventor: Francis Heyes, Lincoln (GB)

Correspondence Address: EGBERT LAW OFFICES, 412 MAIN STREET, 7TH FLOOR, HOUSTON, TX, 77002, US

(21) Appl. No.: 11/919,093

(22) PCT Filed: Apr. 20, 2006
(86) PCT No.: PCT/EP2006/061687

§ 371 Date: Oct. 23, 2007

(30) Foreign Application Priority Data
Apr. 23, 2005 (GB) 0508219.3

(51) Int. Cl. F02B 33/44; F01D 17/12

(52) U.S. Cl. 60/611; 415/160

(57) ABSTRACT

A turbocharger for an internal combustion engine comprising: a turbine driven by exhaust gas from the engine; a compressor for supplying compressed air to the engine, the compressor including an impeller driven by the turbine; an arrangement upstream of the impeller suitable for directing air such that it is swirling in a rotational sense on reaching the impeller; and control means arranged to control said arrangement such that as the speed of the impeller approaches a predetermined maximum speed limit the arrangement directs air such that it is swirling in the opposite rotational sense to that in which the impeller is being driven by the turbine.

### CROSS REFERENCE TO RELATED APPLICATIONS

This application is the US National Stage of International Application No. PCT/EP2006/061687, filed Apr. 20, 2006 and claims the benefit thereof. The International Application claims the benefits of British application No. 0508219.3 filed Apr. 23, 2005, both of the applications are incorporated by reference herein in their entirety.

### FIELD OF INVENTION

This invention relates to a turbocharger for an internal combustion engine.

### SUMMARY OF INVENTION

More particularly, the invention relates to a turbocharger for an internal combustion engine comprising: a turbine driven by exhaust gas from the engine; a compressor for supplying compressed air to the engine, the compressor including an impeller driven by the turbine; a series of variable position guide vanes upstream of the impeller for directing air such that it is swirling in a rotational sense on reaching the impeller; and control means for varying the position of the guide vanes.

In order to meet emission regulations applicable to medium speed four-stroke diesel engines it is known to use so called Miller timing. In Miller timing the engine inlet valve is closed before bottom dead centre and the charge air is cooled by an expansion process at the end of the induction stroke. This reduces cylinder firing temperature and formation of NOX (nitrogen oxides).

As regards the turbocharger for such engines, this requires a higher pressure ratio, typically above 5, and for engine overload conditions a pressure ratio above 5.2 is desirable.

In order to increase the pressure ratio the rotational speed of the compressor of the turbocharger must be increased. This increases centrifugal loading and hence material stress on the impeller of the compressor, which stress increases with the square of rotational speed.

The temperature of the air washed surfaces of the impeller also increases with rotational speed. This is so by conservation of rothalpy. In approximation the temperature T of the impeller at radius r is given by T=Tamb+(Ω²r²/2 Cp), where Tamb is the stagnation temperature at the impeller inlet (typically the ambient temperature), Ω is the speed of the impeller in radians per second, and Cp is the air specific heat capacity at constant pressure.

It is to be noted that particularly at high pressure ratios, when the flow into the impeller is tending to choke, a small increase in pressure ratio as the engine load rises can only be obtained by a large increase in impeller speed.

Traditionally turbocharger impellers are made from an aluminium alloy and are typically required to achieve a 50,000 hour life. The life is limited by low cycle fatigue (peak stresses and the cyclic duty) and by creep (peak stresses and temperature). This translates into a maximum pressure ratio capability of between 4.5 and 5 for a 45° C. ambient temperature depending on the particular design. In this regard the high ambient temperature is considered typical of many marine engine rooms.

It is desired to achieve higher pressure ratios whilst at the same time not sacrificing impeller life.

It is known to do this by changing the material of the impeller. Steel could be used, but this has a very high density and the inertia of the impeller and consequent turbo-lag effectively rules out this option in most cases. Titanium is usually used for higher pressure ratio/temperature applications. This also has a higher density than aluminium, but considerably less than steel and as a consequence is often acceptable. The cost of replacing an aluminium impeller with a titanium impeller is in many cases prohibitive.

It is also known to achieve a higher pressure ratio whilst not sacrificing impeller life by using multistage compression. The compression is split between two aluminium impellers. This may be on the same shaft or by using two turbochargers. This may well be an acceptable approach for higher pressure turbocharging (ratios of 7 and above) where intercooling between the compression stages can be an advantage, but the complexity and cost of this approach is disproportionately high when relatively modest increases in pressure ratio are required.

### SUMMARY OF INVENTION

According to the present invention there is provided a turbocharger for an internal combustion engine comprising: a turbine driven by exhaust gas from the engine; a compressor for supplying compressed air to the engine, the compressor including an impeller driven by the turbine; an arrangement upstream of the impeller suitable for directing air such that it is swirling in a rotational sense on reaching the impeller; and control means arranged to control said arrangement such that as the speed of the impeller approaches a predetermined maximum speed limit the arrangement directs air such that it is swirling in the opposite rotational sense to that in which the impeller is being driven by the turbine.

Preferably, the control means is arranged (i) to apply the swirl in the opposite rotational sense when the speed of the impeller reaches a threshold speed, (ii) to progressively increase the amount of the swirl as the speed of the impeller increases from the threshold speed to the predetermined maximum speed limit, and (iii) at the maximum speed limit to vary the amount of swirl applied so that the speed of the impeller does not exceed the maximum speed limit.

The threshold speed may substantially correspond to the speed of the impeller when the internal combustion engine is operating at 85% full engine load.

The threshold speed may substantially correspond to the speed of the impeller when the internal combustion engine is operating at full load.

Preferably, said arrangement upstream of the impeller suitable for directing air comprises a series of variable position guide vanes, the control means being arranged to vary the position of the guide vanes such that as the speed of the impeller approaches the predetermined maximum speed limit the guide vanes direct air such that it is swirling in the opposite rotational sense to that in which the impeller is being driven by the turbine.

In the turbocharger described below by way of example, the turbine and the impeller rotate about a first axis, and the series of variable position guide vanes are arranged in a circle centred on the first axis, the plane of the circle being perpendicular to the first axis, rotation of the impeller causing air to be drawn radially inwardly with respect to the first axis through the circle of guide vanes and subsequently to travel along the first axis, the air swirling about the first axis as it travels therealong.

Further, in the turbocharger described below, each guide vane includes a shaft extending parallel to the first axis, rotation of each shaft about its own axis varying the angle of inclination its associated guide vane, rotation of the shafts of the guide vanes effecting variation of the amount of swirl applied by the guide vanes.

Further, the turbocharger described below additionally comprises: a linkage mechanism for linking the shafts of the guide vanes, operation of the linkage mechanism causing all shafts to be rotated by the same angle and in the same sense; and an actuator for operating the linkage mechanism, the actuator being under the control of the control means.

### BRIEF DESCRIPTION OF THE DRAWINGS

The invention will now be described, by way of example, with reference to the accompanying drawings, in which:

FIG. 1 illustrates a turbocharger in accordance with the present invention;

FIG. 2 is a cross-section on the line A-A in FIG. 1;

FIG. 3 is a view on arrow B in FIG. 1;

FIG. 4 is a graph of pressure ratio versus mass flow for turbochargers both incorporating and not incorporating the present invention at three speeds of operation; and

FIG. 5 is a graph of rotational speed versus pressure ratio for a turbocharger both incorporating and not incorporating the present invention.

### DETAILED DESCRIPTION OF INVENTION

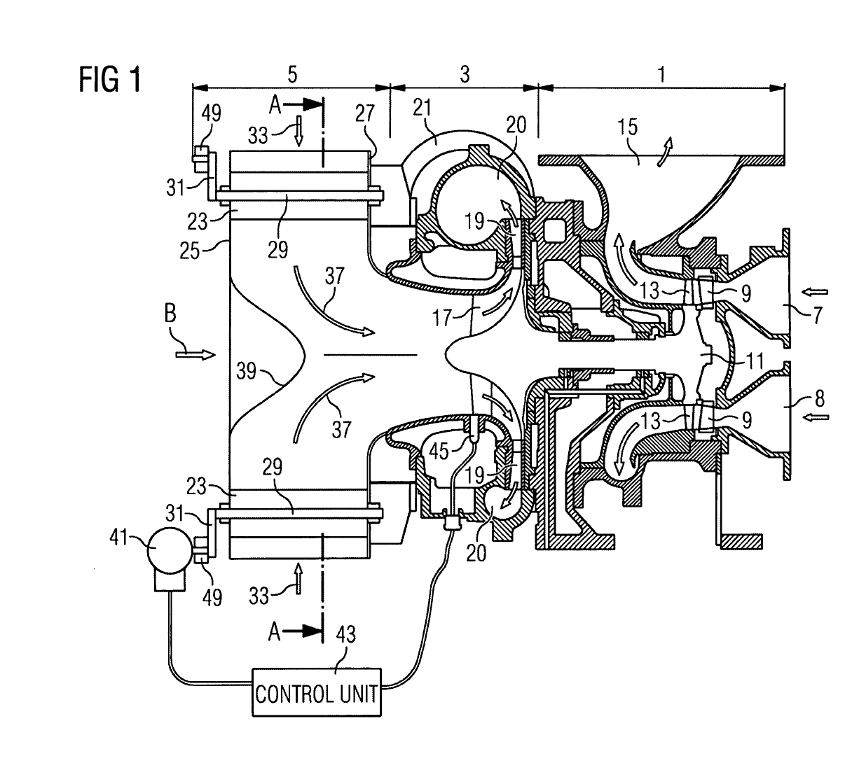

Referring to FIG. 1, the turbocharger comprises a turbine section 1, a compressor section 3, and a guide vane section 5.

In turbine section 1, exhaust gas enters via openings 7, 8 which merge so as to provide an annular gas supply to stationary guide vanes 9. The gas drives rotor 11 by means of rotor vanes 13, and thereafter is collected and channeled by the turbine section casing to leave the section via opening 15.

In compressor section 3, an impeller 17 driven by rotor 11 draws air from guide vane section 5, compresses this air, and passes it to diffuser 19. The air travels from diffuser 19 to scroll like volute 20, and then leaves volute 20 and compressor section 3 via an opening surrounded by flange 21. The air travels in a direction into the paper when leaving via this opening.

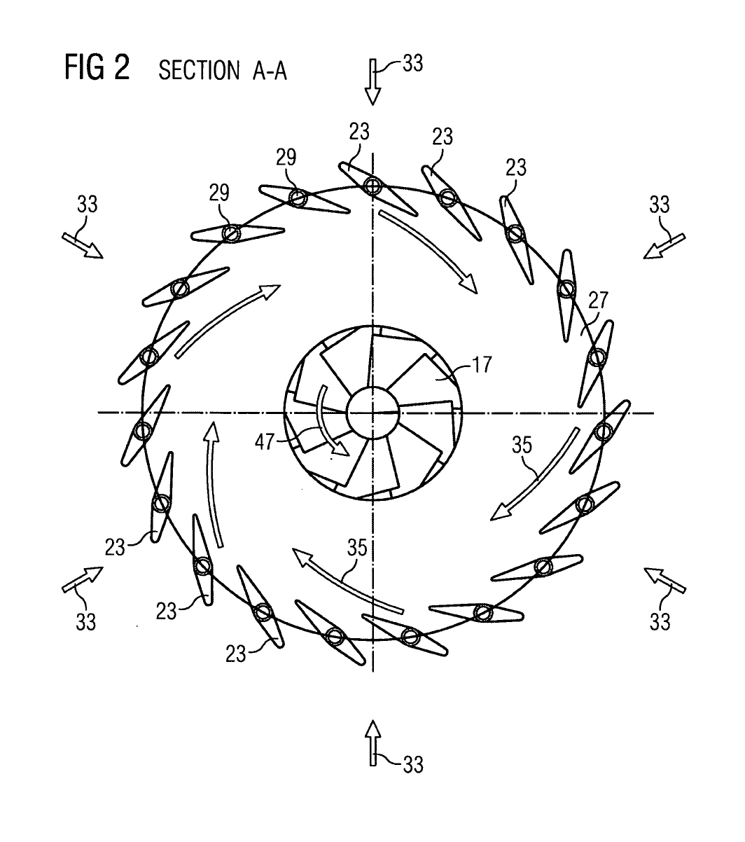

Referring also to FIG. 2, guide vane section 5 comprises a series of variable position guide vanes 23 arranged in a circle and secured between opposing sides 25, 27 of the casing of guide vane section 5. Each guide vane 23 includes a shaft 29 mounted on casing sides 25, 27. Each shaft 29 is able to rotate about its own axis thereby to vary the angle of inclination of its guide vane 23.

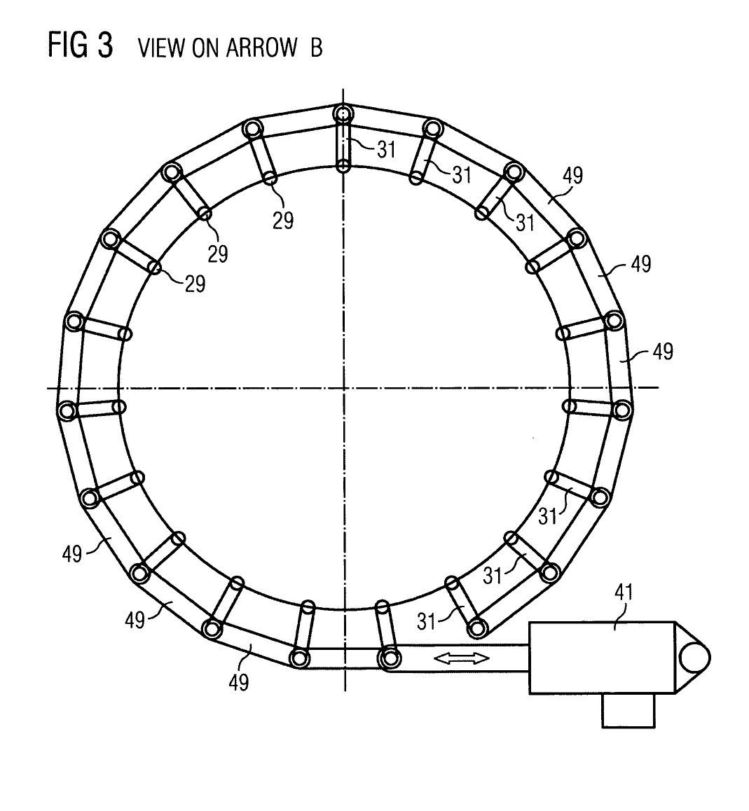

Referring also to FIG. 3, connected to each shaft 29 is an arm 31 which in turn is connected to a linkage mechanism 49 that connects all arms 31. Actuation of linkage mechanism 49 causes all shafts 29 to be rotated by the same angle and in the same sense.

Rotation of impeller 17 causes air to be drawn in the direction of arrows 33 radially inwardly between casing sides 25, 27 and through guide vanes 23. Guide vanes 23 direct the air so as to cause the air to swirl in either a clockwise or anticlockwise sense or not at all depending on the setting of the guide vanes, as the air is drawn towards the impeller. Arrows 35 indicate the swirl caused by guide vanes 23, and arrows 37 indicate the drawing of the air towards the impeller. A conical protrusion 39 in casing side 25 assists in the aerodynamics of guide vane section 5.

The turbocharger further comprises an actuator 41 for operating linkage mechanism 49, a control unit 43 for controlling the operation of actuator 41, and a speed sensor 45 for sensing the speed of impeller 17.

Associated with impeller 17 is a maximum speed limit which the impeller must not exceed if it is to have a required lifetime, as explained in the introduction to the present application. It is desired that as the speed of impeller 17 approaches this maximum speed limit guide vanes 23 direct air such that it is swirling in the opposite rotational sense to that in which impeller 17 is being driven by turbine section 1, i.e. guide vanes 23 apply negative pre-swirl. As will be explained below, this enables higher compressor pressure ratios to be achieved without exceeding the maximum speed limit.

In FIG. 2 guide vanes 23 apply negative pre-swirl. This is shown by arrows 35 indicating swirl in a clockwise sense and arrow 47 indicating rotation of impeller 17 in an anticlockwise sense. It is to be noted that when guide vanes 23 extend precisely radially no pre-swirl is applied by the vanes. If the guide vanes are then rotated from this position in an anticlockwise sense, then negative pre-swirl is applied. If the guide vanes are rotated not anticlockwise but clockwise, then positive pre-swirl is applied, i.e. swirl in the same direction as that in which the impeller is rotating.

A threshold impeller speed is assigned at which guide vanes 23 will be operated so that they apply negative pre-swirl. The aim is that the engine will be operating at approximately full load when the threshold speed is sensed. Consequently, in known manner, see below, guide vanes 23 will extend either precisely radially or apply only a small amount of positive pre-swirl when threshold speed is sensed. It is to be noted that for many marine applications engines are required to operate safely up to 110% rated engine load for one hour in twelve. It is in these overload conditions, when availability of power is necessary, but efficiency is not paramount, that negative pre-swirl is important in protecting the life of the impeller.

In response to speed sensor 45 sensing the threshold impeller speed, control unit 43 controls actuator 41 to operate linkage mechanism 49 so that guide vanes 23 apply negative pre-swirl. As the speed of impeller 17 progressively increases from the threshold speed towards the maximum speed limit, control unit 43 controls the angle of inclination of guide vanes 23 so as to progressively increase the amount of negative pre-swirl applied. In FIG. 2 this corresponds to the progressive rotation of each guide vane 23 at the same rate in an anticlockwise sense. At the maximum speed limit the amount of negative pre-swirl may be increased to a maximum value to achieve an increase in pressure ratio without exceeding this maximum speed limit, see below.

It is known to use positive pre-swirl at low engine load to increase both compressor efficiency and stall margin. Negative pre-swirl at low load, although having the undesirable effect of reducing both efficiency and stall margin, is able to lower compressor speed for a given pressure ratio. It is this property that is utilised by the present invention at high load.

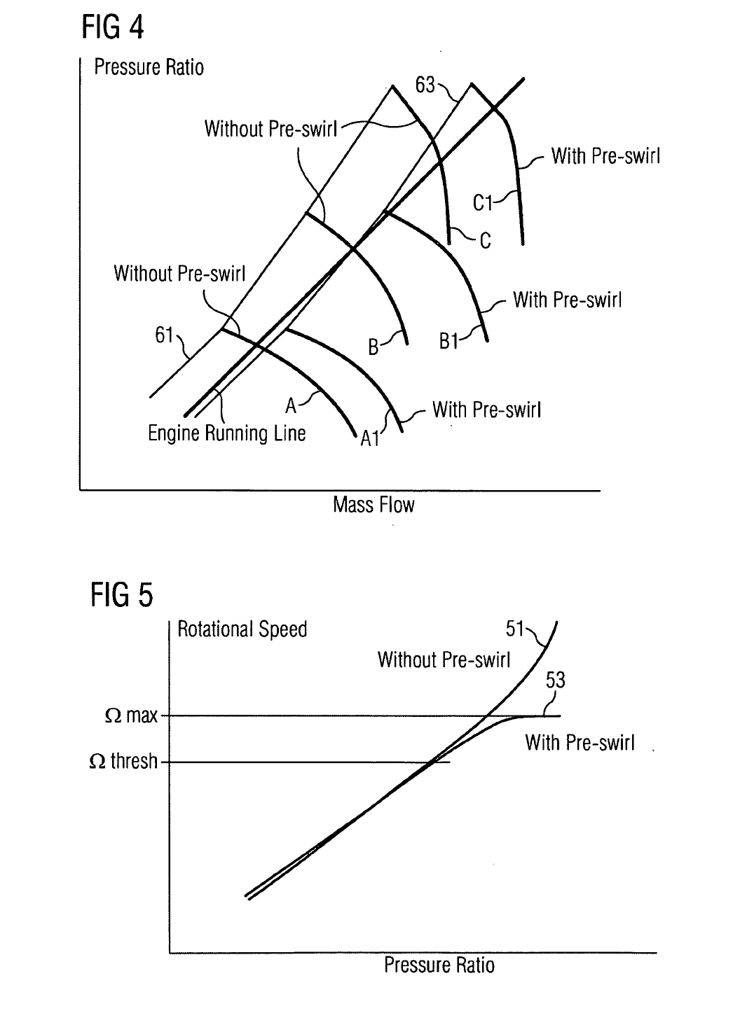

The flow leaving the impeller swirls in the direction of impeller rotation. If the flow entering the impeller also swirls in this direction, i.e. there is positive pre-swirl, then, as compared to the case where there is negative pre-swirl, not as much work is done on the flow by the impeller. In general, this means that where there is negative pre-swirl, the compressor pressure ratio is higher. However, the main change to the compressor characteristic is not pressure ratio at a given speed, but mass flow, see the graph of FIG. 4 discussed below. This also means that, on an engine running line, a higher pressure ratio may be achieved at a given speed using negative pre-swirl, even though the peak pressure ratio on a given speed line may be the same as with no negative pre-swirl, again see the graph of FIG. 4.

Referring to FIG. 4, curve A is a plot of compressor pressure ratio versus mass flow at a first constant compressor speed and without the use of negative pre-swirl, and curve A1 is a plot of compressor pressure ratio versus mass flow at the same first constant compressor speed but with the use of negative pre-swirl. Curves B, B1 and C, C1 correspond to curves A, A1, but in the case of curves B, B1 the constant compressor speed is a second speed higher than the first speed, and in the case of curves C, C1 the constant compressor speed is a third speed higher than the second speed. It will be seen that in the case of all three constant compressor speeds, on the engine running line, the use of negative pre-swirl increases the pressure ratio and mass flow at the constant speed concerned.

In FIG. 4, line 61 is the compressor surge line without negative pre-swirl, and line 63 the compressor surge line with negative pre-swirl. In general, operation to the left of the surge lines 61, 63 cannot be achieved due to surging of the compressor. As regards surge line 61, it can be seen that at all speeds/loads the engine running line is to the right of this surge line. Thus, when no negative pre-swirl is applied, operation is possible at all points along the engine running line. However, in the case of surge line 63, it is only at high speed/load that the engine running line is to the right of this surge line. Thus, when negative pre-swirl is applied, operation is possible only at high speed/load points on the engine running line. This does not present a problem as the present invention concerns operation at high speed. In other words, the application of negative pre-swirl has the effect of moving the compressor surge line to the right reducing surge margin, and limits operation to high speed/load points on the engine running line. However, as the present invention concerns a problem that occurs at high compressor speed, negative pre-swirl may be used to address this problem.

Referring to FIG. 5, curve 51 is a plot of compressor rotational speed versus pressure ratio on an engine running line without the use of negative pre-swirl, and curve 53 is a plot of compressor rotational speed versus pressure ratio on the same engine running line with the use of negative pre-swirl. In the case of curve 53, negative pre-swirl is introduced at a threshold rotational speed Ω thresh. From Ω thresh to a maximum speed limit Ω max the amount of negative pre-swirl is progressively increased. At Ω max the amount of negative pre-swirl is increased to a maximum value. Returning to curve 51, above Ω thresh to achieve an increase in pressure ratio becomes increasingly difficult as curve 51 becomes increasingly steeper above Ω thresh requiring a greater increase in rotational speed to achieve a given increase in pressure ratio. To the contrary, in the case of curve 53, above Ω thresh the gradient of curve 53 progressively reduces, requiring a smaller increase in rotational speed to achieve a given increase in pressure ratio. This is because the applied negative pre-swirl is assisting in the increase in pressure ratio. At Ω max an increase in pressure ratio is achieved solely by means of increasing the amount of negative pre-swirl and without any increase in rotational speed.

It is to be understood that the adjustment of guide vanes 23 should be smooth and gradual, and proportional to the turbocharger speed, such that there is no sudden change in turbocharger speed. In the case where there is a sudden reduction in engine load, the engine may over-speed whilst the fuel supply adjusts to the new requirements. This would increase the mass flow through the compressor and possibly the pressure ratio potentially increasing turbocharger speed. This would have the result of more negative pre-swirl being applied to reduce turbocharger speed. As the fuel supply to the engine then reduces, the temperature of the gas entering the turbine reduces, and consequently the power passed to the compressor reduces, reducing compressor speed. This will cause a corresponding reduction in the amount of negative pre-swirl applied. Of course, in the case where an emergency shedding of engine load takes place, a so called wastegate may be used which diverts exhaust gas so that it does not reach the turbocharger turbine.

In the above description the threshold speed at which negative pre-swirl is first introduced corresponds to approximately full engine load. It is to be appreciated that negative pre-swirl could be used to reduce compressor speed at speeds lower than that corresponding to full load. Of course, negative pre-swirl cannot be used at speeds lower than that corresponding to the point at which surge line 63 crosses the engine running line in the graph of FIG. 4. The lower limit compressor speed at which negative pre-swirl could first be introduced is chosen to be somewhat above this crossover point, and is typically a speed corresponding to 85% full engine load.

In the above description a series of variable position guide vanes are used to apply the negative pre-swirl. It is to be appreciated that the negative pre-swirl could be applied in other ways. All that is required is an arrangement suitable for directing air such that the air on reaching the impeller is swirling in the opposite rotational sense to that in which the impeller is being driven by the turbine. For example, such an arrangement might direct a proportion of the air intake to the compressor through a pipe or pipes mounted off-centre of the turbocharger axis, with the amount of air entering through the pipe or pipes being controlled by a valve thereby to adjust the amount of negative pre-swirl applied.

1.-9. (canceled)

10. A turbocharger for an internal combustion engine comprising:
a turbine driven by exhaust gas from the engine;
a compressor for supplying compressed air to the engine, the compressor having an impeller driven by the turbine wherein the turbine and the impeller rotate about a first axis;
a plurality of variable position guide vanes arranged upstream of the impeller in a circle centered on the first axis that rotationally direct a compressor inlet air approaching the impeller to pre-rotate the air upon reaching the impeller, where
a plane of the circle is arranged perpendicular to the first axis and each guide vane having a shaft extending parallel to the first axis,
rotation of each shaft about its own axis varies the angle of inclination of the associated guide vane,
rotation of the shafts of the guide vanes effecting variation of the amount of swirl applied by the guide vanes, wherein the rotation of the impeller causing air to be drawn radially inwardly with respect to the first axis through the circle of guide vanes and subsequently to travel along and swirl about the first axis; and
a position control device that controls the position of the guide vanes such that as the speed of the impeller approaches a predetermined maximum speed limit the control device directs the compressor inlet air approaching the impeller to swirl in a rotational direction opposite the direction of the impeller, wherein the position control device comprises a linkage mechanism for linking the shafts of the guide vanes, operation of the linkage mechanism causing all shafts to be rotated by the same angle and in the same sense; and an actuator for operating the linkage mechanism, the actuator being under the control of the control device.

11. The turbocharger according to claim 10, wherein the control device is constructed and arranged:
to apply the swirl in the opposite rotational sense when the speed of the impeller reaches a threshold speed,
to progressively increase the amount of the swirl as the speed of the impeller increases from the threshold speed to the predetermined maximum speed limit, and
at the maximum speed limit to vary the amount of swirl applied so the speed of the impeller does not exceed the maximum speed limit.

12. The turbocharger according to claim 11, wherein the threshold speed substantially corresponds to the speed of the impeller when the internal combustion engine is operating at 85% full engine load.

13. The turbocharger according to claim 11, wherein the threshold speed substantially corresponds to the speed of the impeller when the internal combustion engine is operating at full load.

14. The turbocharger according to claim 11, wherein the internal combustion engine is a diesel engine.

15. The turbocharger according to claim 14, wherein the diesel engine operates using Miller timing.

16. A turbocharged internal combustion engine utilizing Miller timing, comprising:
a cylinder having an associated inlet valve that inlets an intake air to the cylinder;
an exhaust valve associated with the cylinder that exhausts an exhaust gas from the cylinder into an exhaust tract;
a turbine arranged in the exhaust tract that converts thermodynamic energy of the exhaust gas into mechanical shaft energy;
a shaft connected to the turbine that rotates about a first axis;
a compressor connected to and driven by the turbine via the shaft, wherein the compressor supplies compressed air to the engine, and comprises:
an impeller,
a plurality of variable position guide vanes arranged upstream of the impeller in a circle centered on the first axis that rotationally direct the inlet air approaching the impeller to pre-rotate the air upon reaching the impeller, where
a plane of the circle is arranged perpendicular to the first axis and each guide vane having a shaft extending parallel to the first axis,
rotation of each shaft about its own axis varies the angle of inclination of the associated guide vane,
rotation of the shafts of the guide vanes effecting variation of the amount of swirl applied by the guide vanes, wherein the rotation of the impeller causing air to be drawn radially inwardly with respect to the first axis through the circle of guide vanes and subsequently to travel along and swirl about the first axis, and
a position control device that controls the position of the guide vanes such that as the speed of the impeller approaches a predetermined maximum speed limit the control device directs the compressor inlet air approaching the impeller to swirl in a rotational direction opposite the direction of the impeller, wherein the position control device comprises a linkage mechanism for linking the shafts of the guide vanes, operation of the linkage mechanism causing all shafts to be rotated by the same angle and in the same sense; and an actuator for operating the linkage mechanism, the actuator being under the control of the control device.
